(19) United States
(12) Patent Application Publication
(10) Pub. No.: US 2026/0032543 A1
(43) Pub. Date: Jan. 29, 2026

(54) NON-TRANSITORY COMPUTER-READABLE STORAGE MEDIUM STORING PROGRAM, INFORMATION PROCESSING APPARATUS, AND METHOD

(71) Applicant: CANON KABUSHIKI KAISHA, Tokyo (JP)

(72) Inventor: YOSHIRO MIHIRA, Tokyo (JP)

(21) Appl. No.: 19/271,898

(22) Filed: Jul. 17, 2025

(30) Foreign Application Priority Data
Jul. 24, 2024 (JP) 2024-118762

(51) Int. Cl. H04W 36/08; H04W 76/14

(52) U.S. Cl. CPC H04W 36/08; H04W 76/14

(57) ABSTRACT

An information processing apparatus executes connection setting processing for connecting a communication apparatus to an access point outside the information processing apparatus and the communication apparatus; acquires registration information for registering the communication apparatus in an external server; searches for the communication apparatus via the external access point after executing the connection setting processing; and transmits, in a case where the communication apparatus is not discovered as a result of the search, the acquired registration information to the server.

### BACKGROUND

### Field of the Technology

The present disclosure relates to a non-transitory computer-readable storage medium storing a program, an information processing apparatus, and a method.

### Description of the Related Art

At the time of purchase of a printer, to execute printing from a client such as a PC or a smartphone, it is necessary to connect the printer to a network to be able to communicate with the client. First, the printer is set in a predetermined mode, and information (SSID, Passkey, and the like) for connecting the printer to an access point is transmitted from an application on the client such as the PC or the smartphone to the printer. After that, the printer is connected to the network.

On the other hand, in a state in which various kinds of devices are connected to a Wi-Fi access point, it is possible to perform communication with another device, which may be a security risk. In the settings of the access point, there is known a network separator function that prevents communication between devices and only allows each device to communicate with the external Internet.

Japanese Patent Laid-Open No. 2016-127570 describes that a printer is registered in a cloud service and is then used via the cloud service.

### SUMMARY

The present disclosure provides a non-transitory computer-readable storage medium storing a program for executing processing of connecting a communication apparatus to an access point and allowing an information processing apparatus to use the communication apparatus, an information processing apparatus, and a method.

The present disclosure in one aspect provides a non-transitory computer-readable storage medium that stores one or more programs including instructions, which when executed by one or more processors of an information processing apparatus, cause the information processing apparatus to: execute connection setting processing for connecting a communication apparatus to an access point outside the information processing apparatus and the communication apparatus; acquire registration information for registering the communication apparatus in an external server; search for the communication apparatus via the external access point after executing the connection setting processing; and transmit, in a case where the communication apparatus is not discovered as a result of the search, the acquired registration information to the server.

According to the present disclosure, it is possible to connect a communication apparatus to an access point and allow an information processing apparatus to use the communication apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing the configuration of a communication system;

FIG. 2 is a block diagram showing the configurations of respective apparatuses;

FIG. 3 is a flowchart illustrating processing in an information processing apparatus;

FIG. 4 is a flowchart illustrating the processing in the information processing apparatus;

FIG. 5 is a flowchart illustrating the processing in the information processing apparatus;

FIGS. 6A to 6D are views each showing a user interface screen;

FIGS. 7A to 7D are views each showing a user interface screen;

FIGS. 8A to 8D are views each showing a user interface screen;

FIG. 9 is a flowchart illustrating processing in the information processing apparatus;

FIGS. 10A to 10D are views each showing a user interface screen;

FIGS. 11A to 11C are views each showing a user interface screen; and

FIGS. 12A and 12B are tables each showing registration data.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

There is a case where information for connecting a communication apparatus such as a printer to an access point is transmitted from an application on an information processing apparatus such as a PC or a smartphone to the communication apparatus, and the communication apparatus is connected to the access point. In this case, depending on the settings of the access point, devices connected to the access point cannot directly communicate with each other, and the information processing apparatus cannot use the communication apparatus. According to the present disclosure, it is possible to connect a communication apparatus to an access point and allows an information processing apparatus to use the communication apparatus.

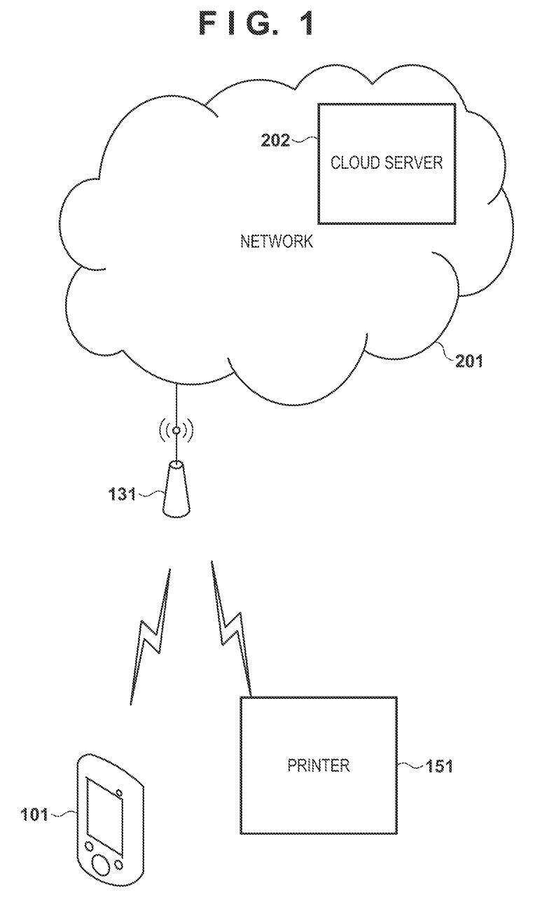

An information processing apparatus and a communication apparatus included in a communication system according to this embodiment will be described. FIG. 1 is a view showing an example of the communication system. In this embodiment, a smartphone is exemplified as an information processing apparatus 101 shown in FIG. 1, but the present disclosure is not limited to this and various kinds of apparatuses such as a portable terminal, a notebook PC, a tablet terminal, a Personal Digital Assistant (PDA), and a digital camera are applicable. As a communication apparatus 151, various kinds of apparatuses are applicable as long as they can perform wireless communication with the information processing apparatus. For example, concerning a printer, an inkjet printer, a full-color laser beam printer, a monochrome printer, and the like are applicable. Furthermore, not only a printer but also a scanner, a copying machine, a facsimile apparatus, a portable terminal, a smartphone, a notebook PC, a tablet terminal, a PDA, a digital camera, a music playback device, a television, a smart speaker, and the like are applicable. In addition, a multi-function peripheral having a plurality of functions such as a copying function, a FAX function, a print function, and a scanner function is also applicable. In this embodiment, the communication apparatus 151 is assumed to be a multi-function printer having a print function and a scanner function. An access point 131 shown in FIG. 1 is a network device to which the information processing apparatus 101 and the communication apparatus 151 are connectable. The access point 131 is connected to a network 201 such as the Internet. The information processing apparatus 101 and the communication apparatus 151 can communicate with a cloud server 202 via the access point 131.

### <Hardware Configuration of Each Apparatus>

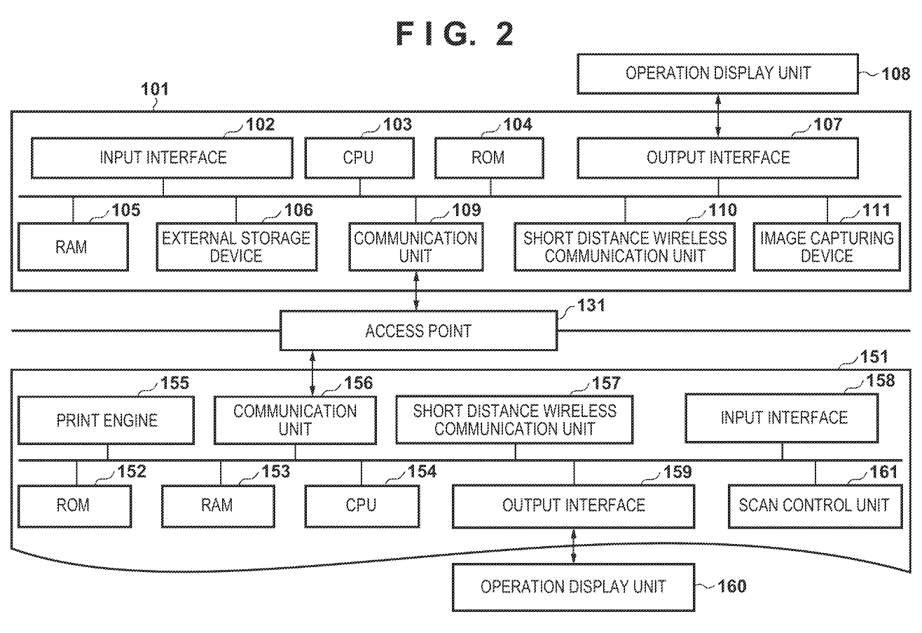

The configuration of the information processing apparatus 101 included in the communication system according to this embodiment, and that of the communication apparatus 151 which can communicate with the information processing apparatus 101 will be explained with reference to the block diagram of FIG. 2. The following configurations will be exemplified in this embodiment, but the present disclosure is not limited to those shown in FIG. 2.

The information processing apparatus 101 includes an input interface 102, a CPU 103, a ROM 104, a RAM 105, an external storage device 106, an output interface 107, an operation display unit 108, a communication unit 109, a short distance wireless communication unit 110, and an image capturing device 111. The input interface 102 is an interface configured to accept a data input and an operation instruction from the user, and is formed by a physical keyboard, display buttons, a touch panel, and the like. Note that the output interface 107 and the input interface 102 (to be described later) may have the same arrangement, and output of a screen and acceptance of an operation from the user may be done by the same arrangement.

The CPU 103 is a system control unit and controls the whole information processing apparatus 101. The ROM 104 stores permanent data such as control programs to be executed by the CPU 103, data tables, and an embedded operating system (to be referred to as an OS hereinafter) program. In this embodiment, the control programs stored in the ROM 104 perform software execution control such as scheduling, task switch, and interrupt processing under the management of the embedded OS stored in the ROM 104.

The RAM 105 is formed by a Static Random Access Memory (SRAM) or the like, which needs a backup power supply. Note that the RAM 105 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 105. Furthermore, the RAM 105 is also used as the main memory and work memory of the CPU 103.

The external storage device 106 includes a setup application program (to be described as a setup application hereinafter) having a function of communicating with the communication apparatus 151 and a function of executing connection setting processing for connecting the communication apparatus 151 to an external access point. The setup application operates on the CPU 103. In addition to the setup application, the external storage device 106 stores an application having a print function for causing the communication apparatus 151 to execute printing, and a scan function for causing the communication apparatus 151 to execute scanning. However, the application is not limited to this form, and may be an application having either of the print function and the scan function, or an application having another function. For example, the application may be, for example, the above-described setup application. The external access point is, for example, the access point 131 to be described later.

The external storage device 106 also has various programs such as a print information generation program for generating print information interpretable by the communication apparatus 151, and an information transmission/reception control program for performing transmission/reception to/from the communication apparatus 151 connected via the communication unit 109. These programs may be programs included in the above-described application or programs configured separately from the application. The external storage device 106 saves various kinds of information to be used by these programs. The external storage device 106 also saves image data obtained from another information processing apparatus or the Internet via the communication unit 109.

The output interface 107 is an interface that performs control for causing the operation display unit 108 to perform display of data and notification of the state of the information processing apparatus 101. The operation display unit 108 is formed by a Light-Emitting Diode (LED), a Liquid Crystal Display (LCD), or the like, and performs display of data and notification of the state of the information processing apparatus 101. Note that a software keyboard including keys such as numerical input keys, a mode setting key, an OK key, a cancel key, and a power key may be provided on the operation display unit 108 so that an input from the user is accepted via the operation display unit 108.

The communication unit 109 is configured to be connected to an apparatus such as the communication apparatus 151 to execute data communication. For example, the communication unit 109 can be connected to an access point (not shown) in the communication apparatus 151. When the communication unit 109 and the access point in the communication apparatus 151 are connected to each other, the information processing apparatus 101 and the communication apparatus 151 can communicate with each other. The access point will sometimes be referred to as an AP hereinafter. Note that the communication unit 109 may directly communicate with the communication apparatus 151 by wireless communication, or may communicate with the communication apparatus 151 via the access point 131 existing outside the information processing apparatus 101 and the communication apparatus 151. As the wireless communication method, the IEEE 802.11 communication standard is used in this embodiment. Note that the IEEE 802.11 communication standard is Wi-Fi^{®}. The communication unit 109 can communicate with the cloud server 202 via the access point 131.

As the access point 131, for example, a device such as a wireless LAN router can be used. Note that in this embodiment, a method of connecting the information processing apparatus 101 and the communication apparatus 151 directly without intervention of the external access point will be referred to as a direct connection method hereinafter. In addition, a method of connecting the information processing apparatus 101 and the communication apparatus 151 via the external access point 131 will be referred to as an infrastructure connection method hereinafter.

The short distance wireless communication unit 110 is configured to be wirelessly connected to an apparatus such as the communication apparatus 151 at a short distance and execute data communication, and performs communication by a communication method different from that of the communication unit 109. The short distance wireless communication method used by the short distance wireless communication unit 110 is, for example, Bluetooth® or Near Field Communication (NFC). Bluetooth may be Bluetooth Classic or Bluetooth Low Energy. The short distance wireless communication unit 110 can be connected to a short distance wireless communication unit 157 in the communication apparatus 151.

The image capturing device 111 is a device that converts an image captured by an image sensor into digital data. The digital data is temporarily stored in the RAM 105. Then, the digital data is converted into a predetermined image format by a program executed by the CPU 103, and saved as image data in the external storage device 106.

The communication apparatus 151 includes a ROM 152, a RAM 153, a CPU 154, a print engine 155, a communication unit 156, the short distance wireless communication unit 157, an input interface 158, an output interface 159, an operation display unit 160, and a scan control unit 161. When a connection mode is set, the communication apparatus 151 can operate in the set connection mode. The connection mode is, for example, a mode for communication by direct connection or a mode for communication by infrastructure connection.

The communication unit 156 is configured to allow the communication apparatus 151 to communicate with another apparatus. In this embodiment, the communication unit 156 performs communication in accordance with the IEEE 802.11 communication standard. The communication unit 156 includes, as an access point in the communication apparatus 151, an access point for performing connection to an apparatus such as the information processing apparatus 101. Note that the access point can be connected to the communication unit 109 of the information processing apparatus 101. Note also that the communication unit 156 may directly communicate with the information processing apparatus 101 by wireless communication, or may communicate with the information processing apparatus 101 via the access point 131. The communication unit 156 may include hardware functioning as an access point, or operate as an access point by software for causing the communication unit 156 to function as an access point. Note that in this embodiment, the communication unit 156 and the short distance wireless communication unit 157 are implemented by one radio chip. That is, in this embodiment, a combo chip corresponding to both a communication function based on the IEEE 802.11 communication standard and a communication function based on the short distance wireless communication method. However, the present disclosure is not limited to this form, and the communication unit 156 and the short distance wireless communication unit 157 may be implemented by separate radio chips.

The RAM 153 is formed by a DRAM or the like that needs a backup power supply. Note that the RAM 153 can store important data such as program control variables without volatilization because the data are held by supplying power (not shown) for data backup. Furthermore, the RAM 153 is used as the main memory and work memory of the CPU 154, operates as a reception buffer for temporarily saving print information received from the information processing apparatus 101 or the like, and saves various kinds of information.

The ROM 152 stores permanent data such as control programs to be executed by the CPU 154, data tables, and an OS program. In this embodiment, the respective control programs stored in the ROM 152 perform software execution control such as scheduling, task switch, and interrupt processing under the management of the embedded OS stored in the ROM 152. In addition, a memory area that stores data necessary to be held even when no power is supplied, such as setting information of the communication apparatus 151 and management data of the communication apparatus 151, is also provided in the ROM 152.

The CPU 154 is a system control unit, and controls the overall communication apparatus 151. Based on the information saved in the RAM 153 or a print job received from the information processing apparatus 101 or the like, the print engine 155 forms an image on a print medium such as a paper sheet using a printing material such as ink and outputs the print result. At this time, the print job transmitted from the information processing apparatus 101 or the like has a large transmission data amount, and high-speed communication is required. Thus, the print engine 155 receives the print job via the communication unit 156 capable of performing communication at a higher speed than the short distance wireless communication unit 157.

The short distance wireless communication unit 157 is configured to be wirelessly connected to an apparatus such as the information processing apparatus 101 at a short distance and execute data communication, and performs communication by a communication method different from that of the communication unit 156. The short distance wireless communication method used in the short distance wireless communication unit 157 is, for example, Bluetooth^{®} or NFC. Bluetooth may be Bluetooth Classic or Bluetooth Low Energy. The short distance wireless communication unit 157 can be connected to the short distance wireless communication unit 110.

The input interface 158 is an interface configured to accept a data input and an operation instruction from the user, and is formed by a physical keyboard, buttons, a touch panel, and the like. Note that the output interface 159 and the input interface 158 (to be described later) may have the same arrangement, and output of a screen and acceptance of an operation from the user may be done by the same arrangement. The output interface 159 is an interface that performs control for causing the operation display unit 160 to perform display of data and notification of the state of the communication apparatus 151.

The operation display unit 160 is formed by a display unit such as a Light-Emitting Diode (LED) or a Liquid Crystal Display (LCD), and performs display of data and notification of the state of the communication apparatus 151. Note that a software keyboard including keys such as numerical input keys, a mode setting key, an OK key, a cancel key, and a power key may be provided on the operation display unit 160 so that an input from the user is accepted via the operation display unit 160.

The scan control unit 161 includes an image sensor unit (reading unit) that executes scanning of a document set on a document table or an Automatic Document Feeder (ADF) (not shown). Note that the image sensor unit includes a light source configured to irradiate a document with light, and an image sensor having an array of elements configured to read the reflected light and photoelectrically convert it. The scan control unit 161 acquires image data by analog/digital (A/D)-converting an analog electrical signal obtained by reading a document by the image sensor unit. The scan control unit 161 also includes a circuit configured to perform direct memory access (DMA) transfer in order to store acquired image data in the RAM 153.

### <Direct Connection Method>

Direct connection indicates a form in which apparatuses are wirelessly connected directly (that is, by Peer to Peer) without intervention of an external apparatus such as the access point 131. As one connection mode, the communication apparatus 151 can operate in a mode (direct connection mode) for communication by direct connection. In Wi-Fi communication, the mode for communication by direct connection includes a plurality of modes such as a software AP mode and a Wi-Fi Direct^{®} mode. Wi-Fi Direct will be referred to as WFD hereinafter.

A mode in which direct connection is executed by WFD is called a WFD mode. WFD is a standard developed by Wi-Fi Alliance and is a standard included in the IEEE 802.11 communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, Go Negotiation in P2P. Note that in the WFD mode in a state before role making is performed, the communication apparatus 151 is neither the master station nor the slave station. More specifically, first, one of devices to communicate with each other issues device search information and searches for a device to be connected in the WFD mode. After the other device serving as a communication partner is discovered, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the communication apparatus 151 may always operate as the GO without executing the above-described GO Negotiation. That is, the communication apparatus 151 may operate in the WFD mode that is an Autonomous GO mode. The state in which the communication apparatus 151 operates in the WFD mode is, for example, a state in which WFD connection is not established but the communication apparatus 151 operates as the GO, or a state in which WFD connection is established and the communication apparatus 151 operates as the GO.

In the software AP mode, one device (for example, the information processing apparatus 101) among devices (for example, the information processing apparatus 101 and the communication apparatus 151) to communicate with each other serves as a client that plays a role of requesting various services. The other device implements the function of an access point in Wi-Fi by software setting. The software AP corresponds to a Wi-Fi master station, and the client corresponds to a Wi-Fi slave station. In the software AP mode, the client searches for a device serving as a software AP by device search information. After the software AP is discovered, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the communication apparatus 151 establishes and maintains direct connection, it operates as a master station in a network to which the communication apparatus 151 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the communication apparatus 151 operates as the master station and can thus decide a specific frequency band and channel to be used for communication in the direct connection mode. In this embodiment, the communication apparatus 151 can use a channel corresponding to the 2.4-GHz frequency band and a channel corresponding to the 5-GHz frequency band for communication in the direct connection mode. Then, the user can arbitrarily set a specific frequency band to be used (or a channel in a specific frequency band to be used) by making a setting on a screen displayed by the communication apparatus 151. In this embodiment, however, even if 5 GHz is selected on the screen displayed by the communication apparatus 151, the communication apparatus 151 does not use a channel corresponding to the Dynamic Frequency Selection (DFS) band in the 5-GHz frequency band for communication in the direct connection mode. In other words, the communication apparatus 151 uses only a channel corresponding to a frequency band other than the DFS band in the 5-GHz frequency band for communication in the direct connection mode. Note that if a radar wave in the frequency band corresponding to the channel is detected in a state in which a channel corresponding to the DFS band is used, the channel currently used needs to be changed. The frequency band in which the channel can be changed by detecting a radar wave is called the DFS band. Note that if, for example, a radio chip corresponding to a DFS function is used, it may be possible to use a channel corresponding to the Dynamic Frequency Selection (DFS) band in the 5-GHz frequency band for communication in the direct connection mode.

### <Infrastructure Connection Method>

Infrastructure connection is a connection form in which devices (for example, the information processing apparatus 101 and the communication apparatus 151) to communicate with each other are connected to an access point (for example, the access point 131) that controls a network of the devices, and the devices communicate with each other via the access point. As one connection mode, the communication apparatus 151 can operate in a mode (infrastructure connection mode) for communication by infrastructure connection.

In infrastructure connection, each device searches for an access point by device search information. After an access point is discovered, the device and the access point perform remaining wireless connection processing (establishment of wireless connection and the like) and then IP connection processing (assignment of an IP address and the like). Note that commands and parameters transmitted/received when implementing wireless connection between the device and the access point suffice to be those defined by the Wi-Fi standard, and a description thereof will be omitted here.

In this embodiment, when the communication apparatus 151 operates in the infrastructure connection mode, the access point 131 operates as a master unit and the communication apparatus 151 operates as a slave unit. That is, in this embodiment, infrastructure connection means connection between the communication apparatus 151 operating as a slave unit and the apparatus operating as a master unit. In a case where the communication apparatus 151 establishes infrastructure connection and the information processing apparatus 101 also establishes infrastructure connection to the access point 131, the communication apparatus 151 and the information processing apparatus 101 can communicate with each other via the access point 131. Since the access point 131 decides a channel to be used for communication in infrastructure connection, the communication apparatus 151 executes communication in infrastructure connection using the channel decided by the access point 131. In this embodiment, the communication apparatus 151 can use a channel corresponding to the 2.4-GHz frequency band and a channel corresponding to the 5-GHz frequency band for communication in infrastructure connection. Note that the communication apparatus 151 can also use a channel corresponding to the DFS band in the 5-GHz frequency band for communication in infrastructure connection. Note also that to communicate with the communication apparatus 151 via the access point 131, the information processing apparatus 101 needs to recognize that the communication apparatus 151 belongs to a network which is formed by the access point 131 and to which the information processing apparatus 101 belongs. Furthermore, in a case where the information processing apparatus 101 and the communication apparatus 151 are connected to the access point 131 by infrastructure connection, the communication apparatus 151 can be discovered by broadcast executed by the information processing apparatus 101.

### <Wireless Setting Processing>

According to this embodiment, by using wireless communication between the information processing apparatus 101 and the communication apparatus 151, the information processing apparatus 101 executes connection setting as setting for operating the communication apparatus 151 by at least one communication method out of the infrastructure connection method and the direct connection method. The connection setting processing according to this embodiment is executed by wireless communication, and is thus called a cableless setup (CLS). Note that the connection setting processing may be executed by wired communication. In a case where the setup application stored in the ROM 104 or the like is activated, the information processing apparatus 101 performs the connection setting processing for the communication apparatus 151. The communication apparatus 151 can operate in a connection setting mode (connection setting state) as a mode for executing the connection setting processing, and executes the connection setting processing in a state in which the communication apparatus 151 operates in the connection setting mode to be described later. Details of the connection setting mode will be described later.

When operating the communication apparatus 151 in the infrastructure connection mode, the information processing apparatus 101 wirelessly transmits, to the communication apparatus 151, infrastructure setting information as setting information for operating the communication apparatus 151 in the infrastructure connection mode. The infrastructure setting information includes connection information for connection to the AP 131. The connection information for connection to the AP 131 is, for example, information concerning a Service Set Identifier (SSID), a password, and a frequency band. On the other hand, when operating the communication apparatus 151 in the direct connection mode, the information processing apparatus 101 wirelessly transmits, to the communication apparatus 151, direct setting information as setting information for operating the communication apparatus 151 in the direct connection mode. The direct setting information includes, for example, an instruction to enable the WFD function to operate the communication apparatus 151 as a group owner or to enable the access point setting of the communication apparatus 151. The information processing apparatus 101 acquires, from the communication apparatus 151, connection information used by the information processing apparatus 101 to perform direct connection to the communication apparatus 151. The connection information used by the information processing apparatus 101 to perform direct connection to the communication apparatus 151 includes, for example, information of the SSID, password, and the like of the communication apparatus 151 that operates in the direct connection mode.

In this embodiment, in the connection setting processing, to transmit the infrastructure setting information or the direct setting information and acquire the connection information used by the information processing apparatus 101 to perform direct connection to the communication apparatus 151, direct connection for connection setting between the information processing apparatus 101 and the communication apparatus 151 is used. Then, in this embodiment, the connection setting processing using Wi-Fi is executed as direct connection for connection setting. However, for example, a wireless communication standard other than Wi-Fi, such as Bluetooth, may be used. Alternatively, a wired communication standard such as a wired LAN or Universal Serial Bus (USB) may be used as direct connection for connection setting.

After infrastructure connection by Wi-Fi or direct connection is established between the information processing apparatus 101 and the communication apparatus 151 by the connection setting processing, the information processing apparatus 101 and the communication apparatus 151 can communicate with each other via the established connection. More specifically, for example, the information processing apparatus 101 can transmit, to the communication apparatus 151 via the established connection, a print job for causing the communication apparatus 151 to execute printing or a scan job for causing the communication apparatus 151 to execute scanning. Note that in this embodiment, it is possible to operate the communication apparatus 151 in the infrastructure connection mode and operate the communication apparatus 151 in the direct connection mode by the connection setting processing, but the present disclosure is not limited to this form. For example, it may be possible to only operate the communication apparatus 151 in the infrastructure connection mode (that is, it may be impossible to operate the communication apparatus 151 in the direct connection mode) by the connection setting processing.

### <Connection Setting Mode>

The communication apparatus 151 can operate in the connection setting mode. A trigger for the communication apparatus 151 to start an operation in the connection setting mode may be, for example, pressing a connection setting mode button by the user or activating (turning on) the communication apparatus 151 for the first time after arrival. The connection setting mode button may be a hardware (physical) button of the communication apparatus 151 or a software button displayed on the operation display unit 160 by the communication apparatus 151.

When the communication apparatus 151 starts an operation in the connection setting mode, it enables Wi-Fi communication. More specifically, as Wi-Fi communication enabling processing, the communication apparatus 151 enables an internal access point (connection setting access point) of the communication apparatus 151 that is dedicated to the connection setting mode. Then, the communication apparatus 151 can establish direct connection to the information processing apparatus 101 by Wi-Fi. Connection information (Service Set Identifier (SSID) and password) for connection to the connection setting access point is held in advance in the setup application installed in the information processing apparatus 101, and the information processing apparatus 101 recognizes in advance the connection information for connection to the connection setting access point. Therefore, unlike the connection information of the access point enabled in the direct connection mode, the connection information for connection to the connection setting access point cannot be changed arbitrarily by the user.

Note that in the connection setting mode, the communication apparatus 151 may be connected to the information processing apparatus 101 by not normal Wi-Fi but Wi-Fi Direct (WFD). That is, the communication apparatus 151 may operate as a group owner and receive a setting command from the information processing apparatus 101 by WFD communication.

Alternatively, the communication apparatus 151 may be connected to the information processing apparatus 101 by Bluetooth in the connection setting mode. Bluetooth includes Bluetooth Classic and Bluetooth Low Energy (BLE). That is, for example, the communication apparatus 151 may operate as a slave apparatus in BLE in the connection setting mode, and receive a setting command from the information processing apparatus 101 by BLE communication. Furthermore, in the connection setting mode, the communication apparatus 151 may be able to execute both connection setting by Wi-Fi and connection setting by BLE. That is, when the communication apparatus 151 starts an operation in the connection setting mode, it may enable both Wi-Fi communication and BLE communication. More specifically, when the communication apparatus 151 starts an operation in the connection setting mode, it may enable both the connection setting access point and an advertising state in which BLE connection is enabled by transmitting advertising information by BLE.

When the communication apparatus 151 operates in the connection setting mode, it controls the communication unit 156 to operate as the connection setting access point that is enabled only during an operation in the connection setting mode. The connection setting access point is an access point different from that enabled in the above-described software AP mode. Assume that the SSID of the connection setting access point includes a predetermined character string recognizable by the setup application of the information processing apparatus 101.

Assume that the communication apparatus 151 operating in the connection setting mode uses a predetermined communication protocol (setup communication protocol) in communication with the information processing apparatus 101 connected to the connection setting access point. More specifically, the setup communication protocol is, for example, Simple Network Management Protocol (SNMP). If a predetermined time elapses after the communication apparatus 151 starts an operation in the connection setting mode, the communication apparatus 151 stops the operation in the connection setting mode and disables the connection setting access point. Furthermore, even when the connection information for connection to the access point 131 and a change instruction of the wireless communication operation mode are received from the information processing apparatus 101 in the connection setting mode, the connection setting access point is disabled.

Assume that the connection setting access point is an access point that does not require a password for connection. Note that the connection setting access point may be an access point that requires a password. In this case, a password used for connection to the connection setting access point is a fixed password (unchangeable by the user) that is grasped in advance by the setup application.

For example, at the time of purchase of a printer, the printer may be set in the connection setting mode, and information (SSID and Passkey) for connecting the printer to the external access point may be transmitted from the setup application on the client such as the PC or the smartphone to the printer and set. However, even if the printer can be connected to the external access point, the client and the printer may not be able to communicate with each other, and it may be impossible to execute printing from the client. For example, in an environment where a network separator is enabled, the devices connected to the external access point cannot directly communicate with each other. In an environment where the network separator is not enabled, the client and the printer can directly communicate with each other. However, in the environment where the network separator is enabled, the client and the printer cannot directly communicate with each other, and it is impossible to execute printing and the like. Not only in the environment where the network separator is enabled but also in a LAN-less environment where all devices can be connected only to the Internet, the client and the printer cannot directly communicate with each other, and it is impossible to execute printing and the like.

According to this embodiment, even in the network separator-enabled environment or in the LAN-less environment where the printer and the client cannot directly communicate with each other, it is possible to use the printer by the normal connection setting processing.

### <Registration of Communication Apparatus in Application>

In this embodiment, the setup application can register the communication apparatus 151 in itself by acquiring information concerning the communication apparatus 151 from the communication apparatus 151. The information concerning the communication apparatus 151 is, for example, the capability information of the communication apparatus 151, the identification information (MAC address or the like) of the communication apparatus 151, the model information of the communication apparatus 151, or the like. More specifically, the capability information of the communication apparatus 151 includes a list of pieces of information of functions supported by the communication apparatus 151, the information of consumables (ink and sheets) usable by the communication apparatus 151, and information indicating the printing method of the communication apparatus 151. Then, the setup application selects one apparatus serving as the partner of communication by the setup application from the one or a plurality of communication apparatuses 151 registered in the setup application. The communication apparatus 151 currently selected as the apparatus serving as the partner of communication by the setup application will be referred to as the currently selected communication apparatus 151 hereinafter. Note that the apparatus serving as the partner of communication by the setup application may be selected by accepting, from the user, selection from the one or a plurality of communication apparatuses 151 registered in the setup application, or may automatically be selected by the setup application in accordance with a predetermined criterion. The apparatus serving as the partner of communication by the setup application may be changed by, for example, accepting, from the user, selection from the one or a plurality of communication apparatuses 151 registered in the setup application. In this embodiment, the setup application transmits various kinds of jobs such as a print job and a scan job to the currently selected communication apparatus 151. That is, the currently selected communication apparatus 151 is an apparatus as the transmission destination of the various kinds of jobs. In this embodiment, the communication apparatus 151 is registered, in the setup application, as a printer with which communication is performed via the cloud server 202 or a printer with which communication is performed without intervention of the cloud server 202. Then, in a case where the currently selected communication apparatus 151 is the communication apparatus 151 registered as a printer with which communication is performed via the cloud server 202, the setup application transmits various kinds of jobs such as a print job and a scan job to the currently selected communication apparatus 151 via the cloud server 202. On the other hand, in a case where the currently selected communication apparatus 151 is the communication apparatus 151 registered as a printer with which communication is performed without intervention of the cloud server 202, the setup application transmits various kinds of jobs such as a print job and a scan job to the currently selected communication apparatus 151 without intervention of the cloud server 202.

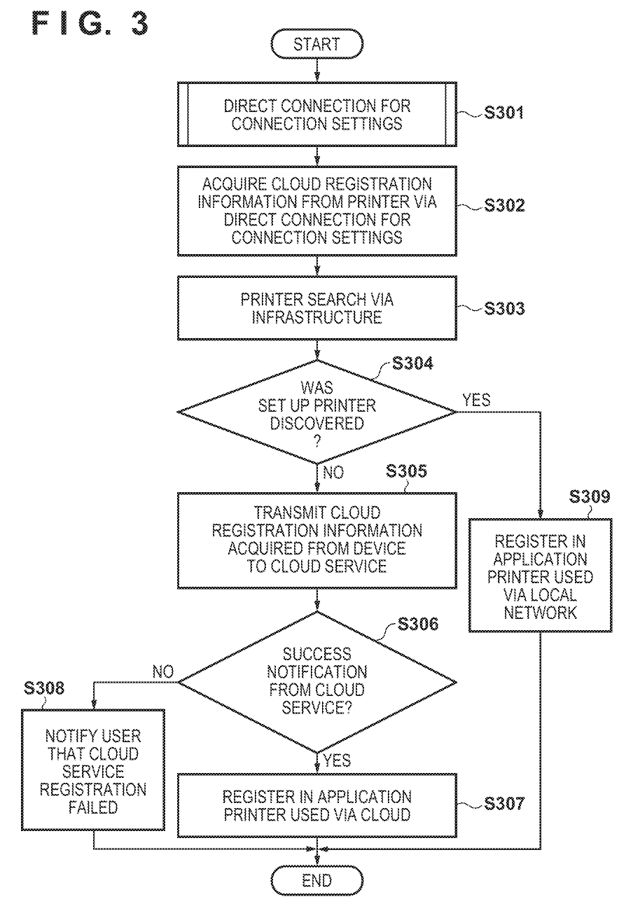

A processing procedure according to this embodiment will be described next with reference to FIGS. 3 to 5 and 9. FIG. 3 is a flowchart illustrating processing including the connection setting processing according to this embodiment. The processing shown in FIG. 3 is implemented when, for example, the CPU 103 of the information processing apparatus 101 reads out the program, such as the setup application, stored in the ROM 104 into the RAM 105 and executes it. This flowchart is started when a predetermined operation for performing the connection setting processing of the communication apparatus 151 is executed on the screen displayed by the setup application.

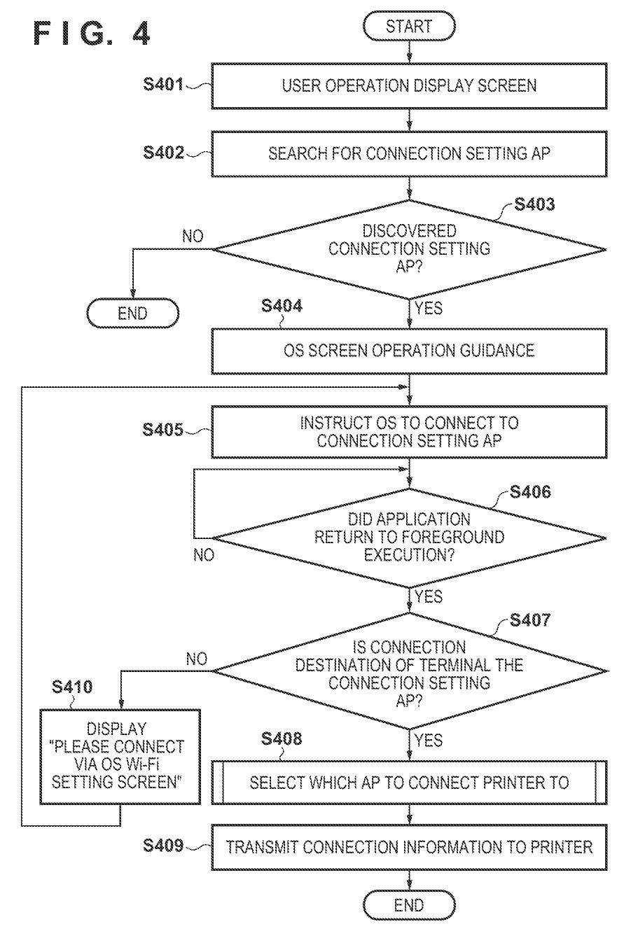

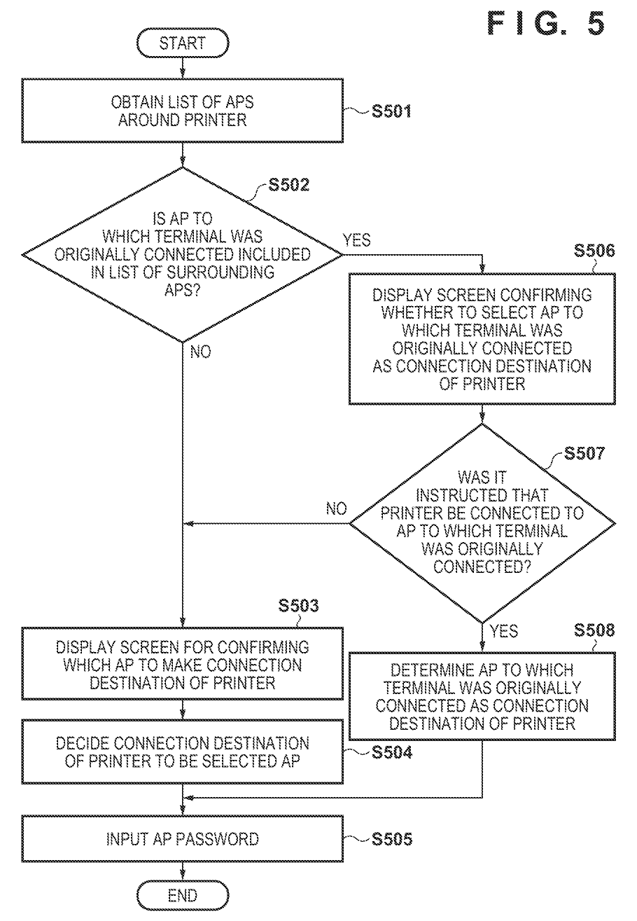

In step S301, to perform the connection setting processing of the communication apparatus 151, the CPU 103 establishes direct connection between the communication apparatus 151 and the information processing apparatus 101. Note that if the information processing apparatus 101 is connected to the access point 131 when the predetermined operation is performed, the CPU 103 saves, in the memory, the information of the access point 131 to which the information processing apparatus 101 is connected when the predetermined operation is performed. After saving the information in the memory, the CPU 103 establishes direct connection between the communication apparatus 151 and the information processing apparatus 101. Step S301 will be described later with reference to FIGS. 4 and 5. Note that when the processing in step S301 is executed, the communication unit 109 of the information processing apparatus 101 is connected to the communication unit 156 operating as the connection setting access point.

In step S302, the CPU 103 acquires cloud registration information from the communication apparatus 151 via the direct connection. The cloud registration information is information necessary to register the communication apparatus 151 in the cloud server 202. More specifically, the cloud registration information includes, for example, the serial number of the printer, license information for registration in the cloud server 202, and device group registration information. In addition, the MAC address of the communication apparatus 151 may be included. Note that the cloud registration information may be acquired before the connection information to the access point is transmitted to the communication apparatus 151 in step S301.

In step S303, the CPU 103 switches the connection of the communication unit 109 from the communication unit 156 operating as the connection setting access point to the access point 131. Note that the access point 131 as the connection target is, for example, the access point 131 to which the information processing apparatus 101 is connected when the predetermined operation is performed. That is, by using the information saved in the memory, the CPU 103 reestablishes the connection between the information processing apparatus 101 and the access point 131 to which the information processing apparatus 101 is connected when the predetermined operation is performed. Then, the CPU 103 searches for the communication apparatus 151 via the access point 131 (infrastructure connection).

In step S304, the CPU 103 determines whether the communication apparatus 151 for which the connection setting processing was performed in step S301 has been discovered. If it is determined that the communication apparatus 151 has been discovered, the process advances to step S309. If it is determined that the communication apparatus 151 has not been discovered, the process advances to step S305.

In step S305, the CPU 103 transmits the cloud registration information acquired in step S302 to the cloud server 202, and executes registration processing of the communication apparatus 151 in the cloud service. Note that if, for example, the cloud registration information transmitted to the cloud server 202 by the information processing apparatus 101 in this processing matches cloud registration information transmitted to the cloud server 202 by the communication apparatus 151 upon completion of the connection setting processing, the registration processing of the communication apparatus 151 in the cloud service succeeds. If the model of the communication apparatus 151 is a registration target model, the registration processing of the communication apparatus 151 in the cloud service succeeds. Note that the present disclosure is not limited to this form. If the cloud server 202 attempts to access the communication apparatus 151 using the cloud registration information transmitted to the cloud server 202 by the information processing apparatus 101, and the access succeeds, the registration processing of the communication apparatus 151 in the cloud service may succeed. If the registration processing of the communication apparatus 151 in the cloud service succeeds, the cloud server 202 transmits a response indicating registration success to the information processing apparatus 101. If the registration processing of the communication apparatus 151 in the cloud service fails, the cloud server 202 transmits a response indicating a registration failure to the information processing apparatus 101. A case where the registration processing fails is, for example, a case where the cloud registration information transmitted to the cloud server 202 by the information processing apparatus 101 in this processing does not match the cloud registration information transmitted to the cloud server 202 by the communication apparatus 151 upon completion of the connection setting processing. There is also a case where the model of the communication apparatus 151 is a model other than the registration target.

In step S306, the CPU 103 determines, based on the response from the cloud server 202 with respect to the transmission in step S305, whether the above-described registration processing succeeds or fails. If it is determined that the registration processing succeeds, the process advances to step S307. If it is determined that the registration processing fails, the process advances to step S308.

In step S307, the CPU 103 identifiably registers the communication apparatus 151 as a cloud printer in the setup application. The cloud printer means a printer which is used (with which communication is performed) via the cloud server 202.

FIGS. 12A and 12B are tables each showing an example of registration data in the setup application. In step S307, for example, the CPU 103 identifiably registers, as the registration data shown in FIG. 12A, the communication apparatus 151 as the cloud printer in the setup application. As shown in FIG. 12A, the registration data is formed as a data set including attributes and values. The attributes are, for example, items including a printer name, a model name, information of whether the communication apparatus is a cloud printer, an IP address, a MAC address, a serial number, color/monochrome, and the presence/absence of a scanner, and the values are pieces of detailed information corresponding to the items. As shown in FIG. 12A, in step S307, information indicating that the communication apparatus is a cloud printer, such as "YES", is stored in the item of the information of whether the communication apparatus is a cloud printer. After step S307, the processing shown in FIG. 3 ends.

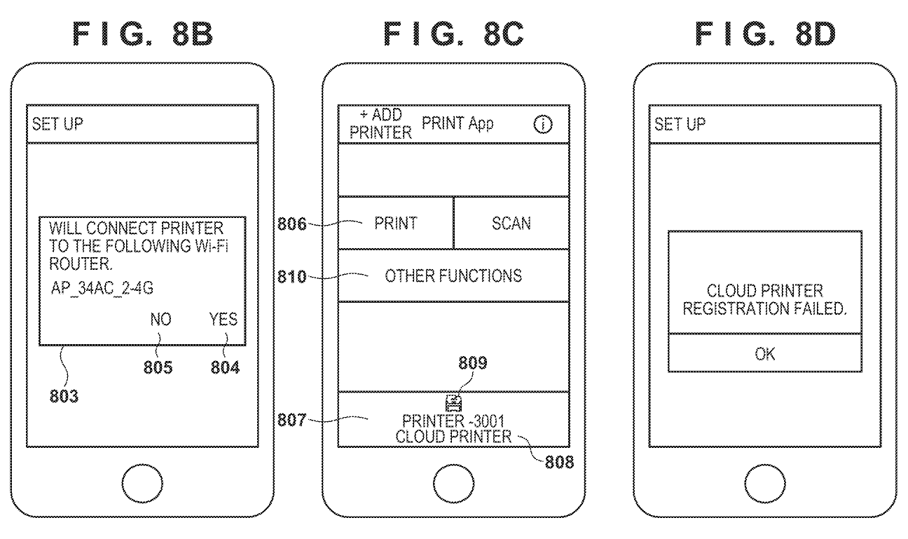

As described above, in this embodiment, the information processing apparatus 101 is directly connected to the communication apparatus 151 operating as the connection setting access point, and acquires, from the communication apparatus 151, information necessary for registration in the cloud service of the cloud server 202. Then, the information processing apparatus 101 switches the connection from the communication apparatus 151 to the access point 131, and registers the communication apparatus 151 in the cloud service of the cloud server 202 using the cloud registration information. When the registration in the cloud service succeeds, the information processing apparatus 101 identifiably registers the communication apparatus 151 as a cloud printer in the setup application. Thus, even if it is impossible to perform communication by infrastructure connection between the information processing apparatus 101 and the communication apparatus 151 because, for example, the function of the network separator is enabled in the access point 131, the communication apparatus 151 can be used as a cloud printer. When the registration data shown in FIG. 12A is registered in the setup application, it is identifiably displayed, on the screen of the setup application, that the communication apparatus is a cloud printer. FIG. 8C shows an example of the home screen of the setup application after the connection setting processing is performed. On the screen shown in FIG. 8C, printer information 807 registered in the setup application in step S307 is displayed, and it is identifiably displayed, by an icon 809 and text 808, that the communication apparatus is a cloud printer.

If it is determined in step S306 that the registration in the cloud service fails, the CPU 103 displays, in step S308, a message indicating that the registration in the cloud service fails. FIG. 8D is a view showing an example of the message displayed in step S308. After step S308, the processing shown in FIG. 3 ends.

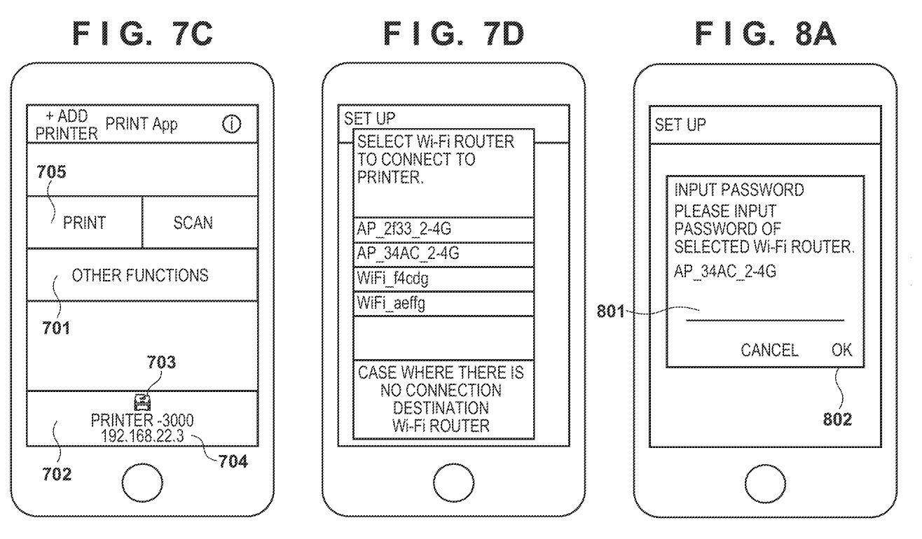

If it is determined in step S304 that the communication apparatus 151 for which the connection setting processing was performed has been discovered, the CPU 103 identifiably registers, in step S309, in the setup application, the communication apparatus 151 as a printer with which communication is performed via the access point 131. In other words, the printer with which communication is performed via the access point 131 is a printer with which communication is performed without intervention of the cloud server 202, and a printer with which communication is performed via a local network formed by the access point 131. Then, the CPU 103 registers the communication apparatus 151 as the registration data shown in FIG. 12B in the setup application. As shown in FIG. 12B, the registration data is different from that shown in FIG. 12A in terms of the following points. That is, information indicating that the communication apparatus is not a cloud printer, such as "NO", is stored in the item of the information of whether the communication apparatus is a cloud printer. The IP address and the MAC address of the communication apparatus 151 are stored in the items of the IP address and the MAC address. In a case where the registration data shown in FIG. 12B is registered, the information processing apparatus 101 executes printing or the like by communicating with the communication apparatus 151 via the access point 131. FIG. 7C shows an example of the home screen of the setup application after the connection setting processing is performed. On the screen shown in FIG. 7C, printer information 702 registered in the setup application in step S309 is displayed together with an icon 703, and the IP address of the communication apparatus 151 is displayed by text 704. After step S309, the processing shown in FIG. 3 ends.

FIG. 4 is a flowchart illustrating the processing in step S301.

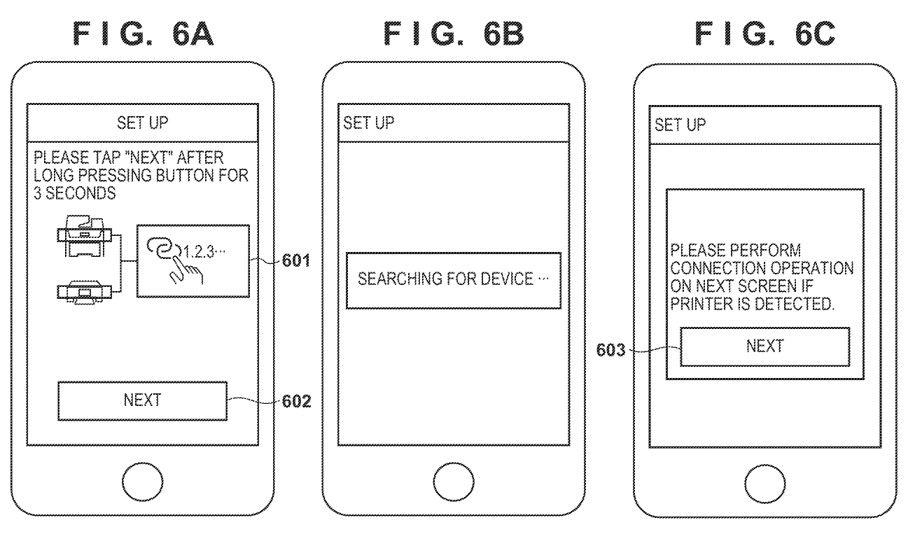

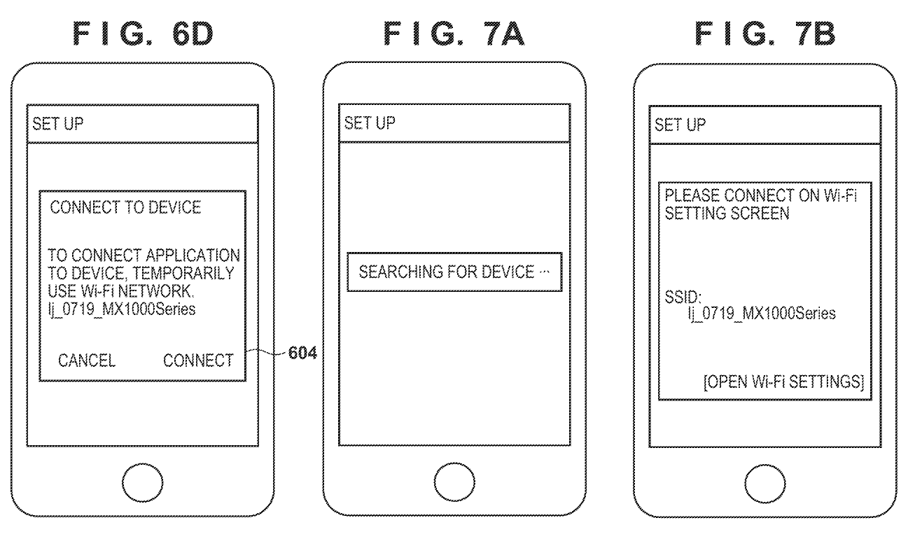

In step S401, the CPU 103 displays, on the operation display unit 108, a screen for instructing the user on a method of shifting the communication apparatus 151 to the connection setting mode. FIG. 6A is a view showing an example of the screen displayed in step S401. The user can shift the communication apparatus 151 to the connection setting mode by pressing a button for shifting the communication apparatus 151 to the connection setting mode in accordance with a guidance 601 on the guidance screen shown in FIG. 6A. Upon accepting the pressing of a button 602 from the user, the process advances to step S402. At this time, the CPU 103 acquires information concerning the access point to which the information processing apparatus 101 is wirelessly connected by Wi-Fi. Note that in this embodiment, since the information processing apparatus 101 does not execute switching of the access point as the connection destination after the above user operation is performed, the access point is the access point to which the information processing apparatus 101 is currently connected in step S401. This information includes connection information (information indicating the SSID and an encryption method, and the like) for connection to the access point to which the information processing apparatus 101 is wirelessly connected by Wi-Fi. Note that the acquired information is saved in a predetermined storage area of the memory of the information processing apparatus 101.

In step S402, the CPU 103 instructs the OS of the information processing apparatus 101 to search for a connection setting access point around the information processing apparatus 101, and acquires a search result by the setup application.

As described above, in this embodiment, the SSID of the access point enabled by the communication apparatus 151 operating in the connection setting mode includes a predetermined character string recognized in advance by the setup application. More specifically, for example, a predetermined character string "ij_" is included, and the CPU 103 searches for an access point with an SSID starting with "ij_". During the search, the CPU 103 displays, on the operation display unit 108, a screen indicating that the search is in progress. FIG. 6B is a view showing an example of the screen displayed in step S402.

In step S403, the CPU 103 determines whether the access point of the printer in the connection setting mode, that is, the connection setting access point has been discovered. If it is determined that the access point has been discovered, the process advances to step S404. If it is determined that the access point has not been discovered, the processing shown in FIG. 4 ends.

In step S404, the CPU 103 displays an OS screen operation guidance on the operation display unit 108. FIG. 6C is a view showing an example of the screen displayed in step S404. The screen shown in FIG. 6C is displayed since it is necessary to accept a user operation on a subsequent OS screen to execute an operation of performing connection to the access point. When the user presses a next button 603 on the screen shown in FIG. 6C, the process advances to step S405.

In step S405, by using the API of the OS, the CPU 103 requests to perform connection to the connection setting access point discovered in step S402. In response to this, the OS displays a screen shown in FIG. 6D. When the OS displays the screen shown in FIG. 6D, the OS screen is on the foreground, and the screen of the setup application is on the background. When the user presses a connection button 604, the OS executes processing for performing connection to the connection setting access point corresponding to the SSID. If the connection to the connection setting access point discovered in step S402 succeeds, the OS ends the display of the screen shown in FIG. 6D, and the screen of the setup application returns to the foreground.

In step S406, the CPU 103 determines whether the screen of the setup application has returned to the foreground. Even if the display of the screen shown in FIG. 6D in step S405 ends, the OS sends no notification of the end. Therefore, in this embodiment, the CPU 103 determines whether the screen of the setup application has returned to the foreground. The processing in step S406 is repeated until it is determined that the screen of the setup application has returned to the foreground. If it is determined that the screen of the setup application has returned to the foreground, subsequent processing is executed.

In step S407, the CPU 103 determines whether the access point to which the information processing apparatus 101 is currently connected is the connection setting access point discovered in step S402. If it is determined that the access point to which the information processing apparatus 101 is currently connected is the connection setting access point discovered in step S402, the process advances to step S408. In step S408, processing of selecting an access point to be connected to the communication apparatus 151 is performed. The processing in step S408 will be described later. After step S408, the CPU 103 transmits, in step S409, the connection information (for example, the SSID) of the access point selected in step S408 to the communication apparatus 151. If the communication apparatus 151 receives the connection information of the access point selected in step S408, the communication apparatus 151 is connected to the access point selected in step S408 by Wi-Fi. After that, the communication apparatus 151 transmits cloud registration information to the cloud server 202, and executes registration processing of the communication apparatus 151 in the cloud service. In step S409, a screen shown in FIG. 7A is displayed. After step S409, the processing shown in FIG. 4 ends.

For example, if the user presses a cancel button on the OS screen shown in FIG. 6D, a screen for selecting another access point is displayed, and an access point other than the connection setting access point discovered in step S402 is selected, it is determined in step S407 that the access point to which the information processing apparatus 101 is currently connected is not the connection setting access point discovered in step S402, and the process advances to step S410. In step S410, the CPU 103 displays a screen shown in FIG. 7B on the operation display unit 108, thereby prompting the user to perform connection to the connection setting access point discovered in step S402. On the screen shown in FIG. 7B, a button for displaying a screen for performing connection to the connection setting access point discovered in step S402 is displayed. After step S410, the processing from step S405 is repeated.

FIG. 5 is a flowchart illustrating the processing in step S408.

In step S501, the CPU 103 requests, from the communication apparatus 151, a list of surrounding access points connectable to the communication apparatus 151, and acquires the list of the access points from the communication apparatus 151. Upon receiving the request of the list, the communication apparatus 151 executes an AP search, and transmits, to the information processing apparatus 101, a list of one or a plurality of access points connectable to the communication apparatus 151, which have been discovered by executing the AP search.

In step S502, the CPU 103 determines whether the list of the access points acquired in step S501 includes the access point originally connected to the information processing apparatus 101. If it is determined that the access point is included, the process advances to step S506. If it is determined that the access point is not included, the process advances to step S503. Note that the information of the access point originally connected to the information processing apparatus 101 is the information concerning the access point saved in the predetermined storage area of the memory of the information processing apparatus 101 in step S401.

If the process advances from step S502 to step S503, the CPU 103 displays, in step S503, on the operation display unit 108, a screen on which it is possible to select an access point as the connection destination of the printer from the access points included in the list acquired in step S501. More specifically, for example, a screen shown in FIG. 7D is displayed.

In step S504, the CPU 103 decides, as the access point to be connected to the communication apparatus 151, the access point selected by the user on the screen displayed in step S503. In step S505, the CPU 103 accepts, from the user, the input of the password of the access point decided in step S504. More specifically, for example, a screen shown in FIG. 8A is displayed. As shown in FIG. 8A, a region 801 for accepting the input of the password from the user is displayed on the screen. When the user inputs the password to the region 801, and then presses an OK button 802, the processing shown in FIG. 5 ends, and the process advances to step S409 of FIG. 4.

If the process advances from step S502 to step S506, the CPU 103 displays, in step S506, a screen capable of accepting an instruction of whether to decide, as the access point to be connected to the communication apparatus 151, the access point originally connected to the information processing apparatus 101. The access point originally connected to the information processing apparatus 101 is the access point 131 to which the information processing apparatus 101 is connected when the predetermined operation is performed. More specifically, for example, a screen shown in FIG. 8B is displayed. As shown in FIG. 8B, a region 803 for displaying the information of the access point originally connected to the information processing apparatus 101 is displayed on the screen.

In step S507, the CPU 103 determines whether to decide, as the access point to be connected to the communication apparatus 151, the access point originally connected to the information processing apparatus 101. More specifically, for example, if a "YES" button 804 is pressed on the screen shown in FIG. 8B, it is determined to decide, as the access point to be connected to the communication apparatus 151, the access point originally connected to the information processing apparatus 101, and the process advances to step S508. On the other hand, if a "NO" button 805 is pressed, it is determined not to decide, as the access point to be connected to the communication apparatus 151, the access point originally connected to the information processing apparatus 101, and the process advances to step S503. In step S508, the CPU 103 decides, as the access point to be connected to the communication apparatus 151, the access point originally connected to the information processing apparatus 101, and the process advances to step S505.

Next, processing in which the setup application of the information processing apparatus 101 instructs the communication apparatus 151 to execute printing will be described.

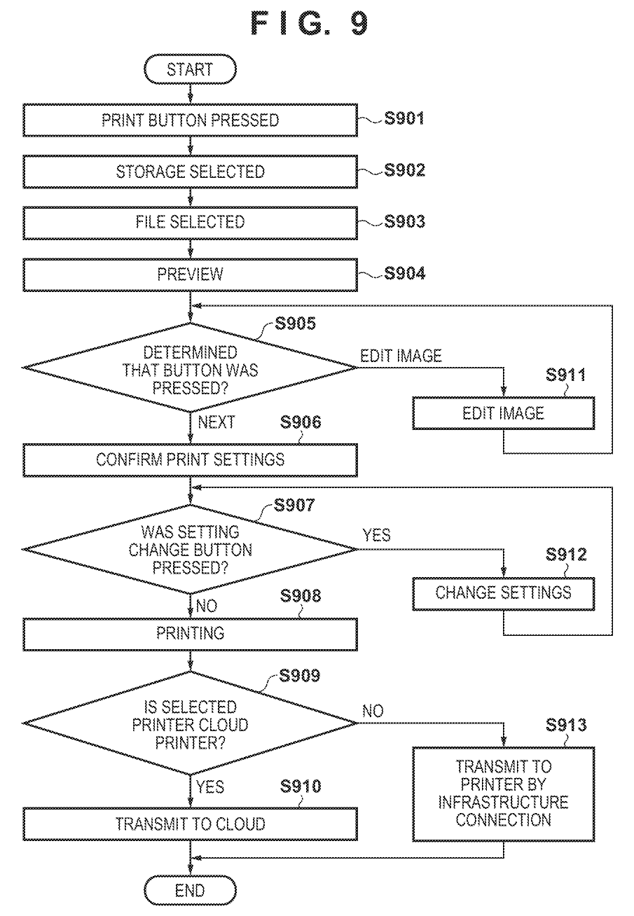

FIG. 9 is a flowchart illustrating the processing in which the setup application of the information processing apparatus 101 instructs the communication apparatus 151 to execute printing. The processing shown in FIG. 9 is implemented when, for example, the CPU 103 of the information processing apparatus 101 reads out the program, such as the setup application, stored in the ROM 104 into the RAM 105 and executes it. The processing shown in FIG. 9 is performed after registration of the communication apparatus 151 in the setup application in the processing shown in FIG. 3. Then, the processing is performed in a state in which the currently selected communication apparatus 151 is specified by selecting one of the communication apparatuses 151 registered in the setup application.

In step S901, the CPU 103 accepts a print start instruction from the user. More specifically, for example, the pressing of a button 705 or 806 indicating "print" is accepted on the screen shown in FIG. 7C or 8C.

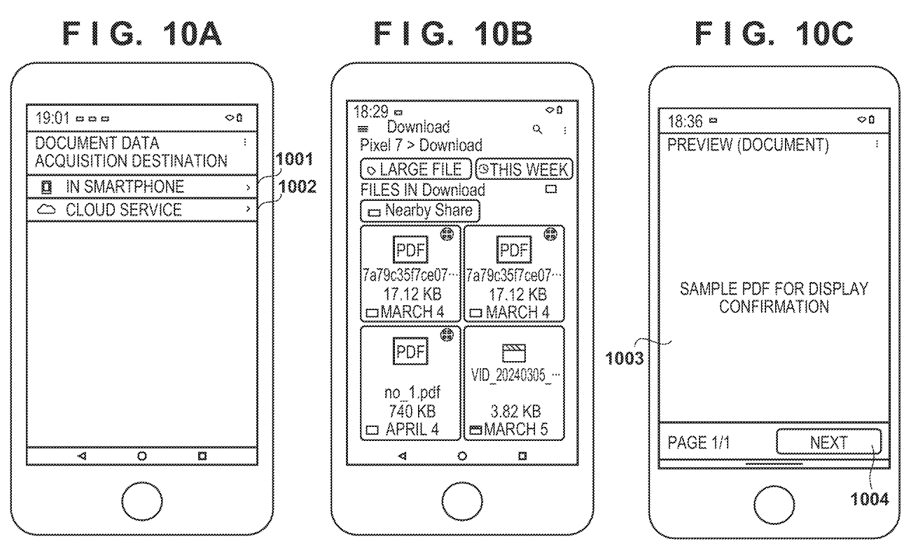

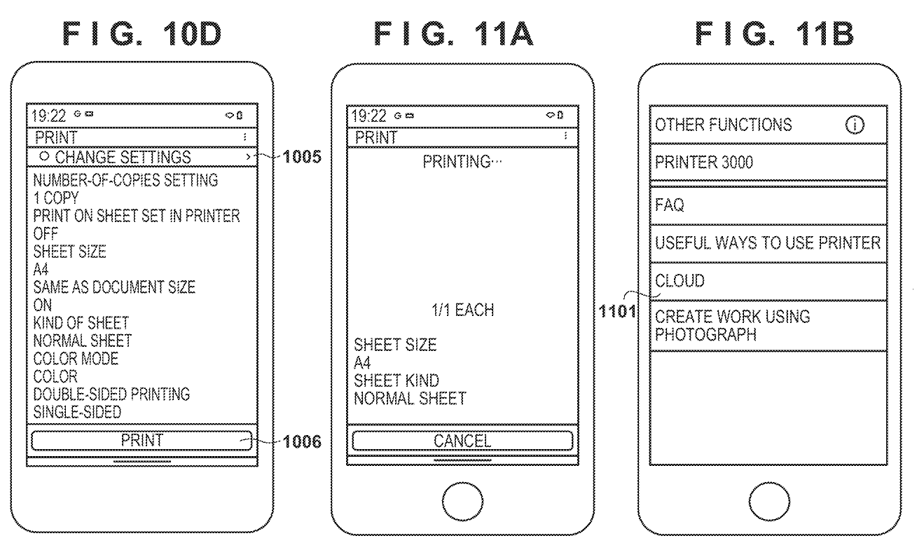

In step S902, the CPU 103 accepts selection of a method of acquiring a print target file from the user. In other words, selection of a storage as the acquisition source of a print target file is accepted. More specifically, for example, the CPU 103 displays a screen shown in FIG. 10A on the operation display unit 108. To acquire a print target file from the external storage device 106 in the information processing apparatus 101, the user presses a button 1001 indicating "smartphone". To acquire a print target file from the cloud storage on the cloud server 202, the user presses a button 1002 indicating "cloud service".

In step S903, the CPU 103 accepts selection of the print target file from the user. More specifically, for example, the CPU 103 displays a screen shown in FIG. 10B on the operation display unit 108. If selection is made on a file selection screen (not shown) from the cloud storage, the selected file is temporarily downloaded from the cloud storage to a primary area of the external storage device 106 of the information processing apparatus 101.

In step S904, the CPU 103 displays a preview of the file selected in step S903. More specifically, for example, a screen shown in FIG. 10C is displayed on the operation display unit 108. A preview image 1003 and a "next" button 1004 are displayed on the screen shown in FIG. 10C. Although not shown in FIG. 10C, an editing button for editing the file of the preview image 1003 may be displayed. This embodiment assumes that the editing button is displayed.

In step S905, the CPU 103 determines the button which has been pressed on the screen displayed in step S904. If it is determined that the editing button has been pressed, the CPU 103 displays, in step S911, on the operation display unit 108, an editing screen (not shown) for editing the file of the preview image 1003. On the editing screen, an image editing function of, for example, trimming the image or performing sepia conversion can be executed. After step S911, the processing from step S905 is repeated. If it is determined in step S905 that the "next" button 1004 has been pressed, the process advances to step S906.

In step S906, the CPU 103 displays a screen for prompting the user to confirm print settings. More specifically, for example, a screen shown in FIG. 10D is displayed on the operation display unit 108. A button 1006 for accepting an instruction to execute printing and a button 1005 for changing the print settings are displayed on the screen shown in FIG. 10D.

In step S907, the CPU 103 determines the button which has been pressed on the screen displayed in step S906. If it is determined that the button for changing the print settings has been pressed, the CPU 103 displays, in step S912, a screen (not shown) for changing the print settings. The user can change the print settings on the screen. After step S912, the processing from step S907 is repeated. If it is determined in step S907 that the button for accepting the instruction to execute printing has been pressed, the process advances to step S908.

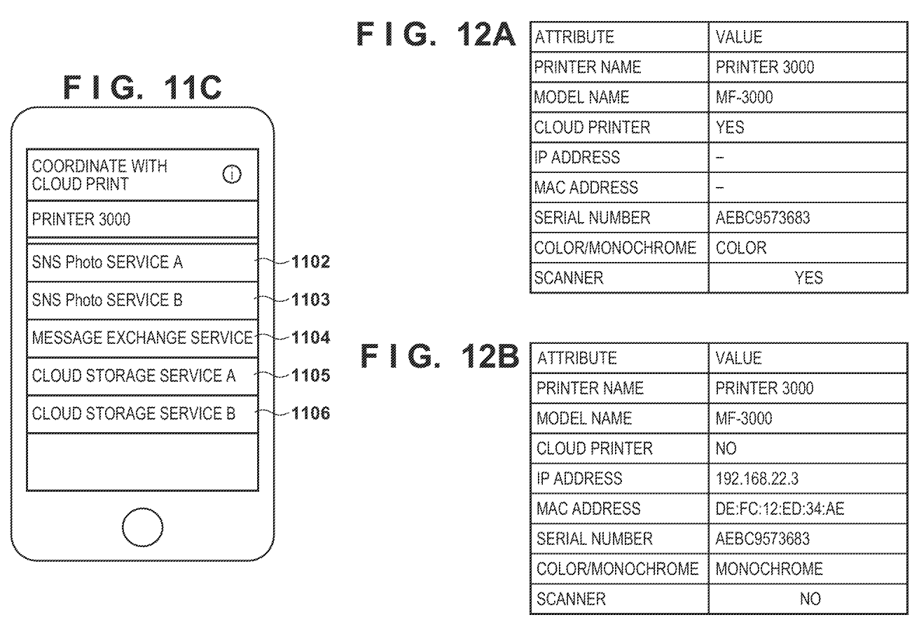

In step S908, the CPU 103 displays a screen indicating that printing is in progress. More specifically, for example, a screen shown in FIG. 11A is displayed on the operation display unit 108. Note that actual print processing is started after step S909.

In step S909, the CPU 103 determines whether the communication apparatus 151 which executes printing is a cloud printer. That is, the CPU 103 determines whether the currently selected communication apparatus 151 is registered as a printer with which communication is performed via the cloud server 202 or a printer with which communication is performed without intervention of the cloud server 202. Then, if the CPU 103 determines that the communication apparatus 151 which executes printing is a cloud printer (the currently selected communication apparatus 151 is registered as a printer with which communication is performed via the cloud server 202), the process advances to step S910. On the other hand, if the CPU 103 determines that the communication apparatus 151 which executes printing is not a cloud printer (the currently selected communication apparatus 151 is registered as a printer with which communication is performed without intervention of the cloud server 202), the process advances to step S913. More specifically, for example, if detailed information of the item of "whether the communication apparatus is a cloud printer" of the registration data shown in FIG. 12A or 12B indicates the cloud printer, the process advances to step S910. On the other hand, if the detailed information indicates no cloud printer, the process advances to step S913.

In step S910, the CPU 103 transmits, to the cloud server 202 via the access point 131, the file selected in step S903, the print setting information, and the cloud registration information of the communication apparatus 151 acquired in step S302 of FIG. 3. That is, if the communication apparatus 151 is registered as the cloud printer in the setup application, the print processing by the communication apparatus 151 is executed as cloud printing. This transmits, from the cloud server 202 to the communication apparatus 151, the file selected in step S903 and the print job for causing the communication apparatus 151 to execute printing based on the print setting information. Then, in accordance with the print job, the communication apparatus 151 executes printing based on the file selected in step S903 and the print setting information. After step S910, the processing shown in FIG. 9 ends.

In step S913, the CPU 103 transmits, to the communication apparatus 151 via the access point 131, the file selected in step S903, the print setting information, and a print instruction. This transmits the print job for causing the communication apparatus 151 to execute printing based on the file selected in step S903 and the print setting information to the communication apparatus 151 via the access point 131 without intervention of the cloud server 202. Then, in accordance with the print job, the communication apparatus 151 executes printing based on the file selected in step S903 and the print setting information. That is, if the communication apparatus 151 is not registered as a cloud printer in the setup application, the information processing apparatus 101 sends a print instruction to the communication apparatus 151 via infrastructure connection.

As described above, according to this embodiment, even in a case where the information processing apparatus 101 cannot instruct printing since the information processing apparatus 101 and the communication apparatus 151 cannot communicate with each other via the access point 131, printing by the communication apparatus 151 can be executed as cloud printing.

The print target file transmitted to the cloud server 202 in step S910 or transmitted to the communication apparatus 151 in step S913 may be a selected image file of the PDF or JPEG format, or a print format. The print format is, for example, a RAW image format or a Print Description Language (PDL) format interpretable by the printer.

When an "other functions" button 701 on the screen shown in FIG. 7C or an "other functions" button 810 shown in FIG. 8C is pressed, the screen transitions to a screen indicating a list of other functions, as shown in FIG. 11B. When a "cloud" button 1101 is pressed on the screen shown in FIG. 11B, a screen indicating a list of cloud cooperation functions is displayed, as shown in FIG. 11C. On the screen shown in FIG. 11C, "cloud storage service" buttons 1105 and 1106 for executing printing based on data in the cloud storage are selectable. "Photo service" buttons 1102 and 1103 for executing printing based on photo data on the Internet are selectable. In addition, a "message exchange service" button 1104 for printing one printed product by combining a message and photo data on the Internet is selectable.

In a print function implemented by the "cloud storage service" button 1105 or 1106 shown in FIG. 11C, the cloud server 202 acquires data from the cloud storage service, and directly transmits the acquired data to the communication apparatus 151. On the other hand, in a print function implemented by the "cloud service" button 1002 shown in FIG. 10A, data in the cloud storage is temporarily downloaded to the information processing apparatus 101, and transmitted to the cloud server 202 again. Therefore, the user can execute printing after executing, for the data in the cloud storage, the image editing function of the print function of the setup application, for example, the image editing function of trimming an image or performing sepia conversion. In this embodiment, since the two kinds of interfaces including the "cloud service" button 1002 and the "cloud storage service" buttons 1105 and 1106 are provided, the user can edit, in the information processing apparatus 101, the data in the cloud storage at an arbitrary timing.

Other Embodiments Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-118762, filed July 24, 2024, which is hereby incorporated by reference herein in its entirety.

What is claimed is:

1. A non-transitory computer-readable storage medium that stores one or more programs including instructions, which when executed by one or more processors of an information processing apparatus, cause the information processing apparatus to:
execute connection setting processing for connecting a communication apparatus to an access point outside the information processing apparatus and the communication apparatus; acquire registration information for registering the communication apparatus in an external server;
search for the communication apparatus via the external access point after executing the connection setting processing; and
transmit, in a case where the communication apparatus is not discovered as a result of the search, the acquired registration information to the server.

2. The medium according to claim 1, wherein the one or more processors further cause the information processing apparatus to:
receive a notification from the server in accordance with the transmission of the registration information.

3. The medium according to claim 2, wherein the one or more processors further cause the information processing apparatus to:
save, in a case where the notification from the server indicates registration of the communication apparatus in the server succeeds, in the information processing apparatus, information of the communication apparatus as an apparatus to be caused to execute predetermined processing via the server.

4. The medium according to claim 3, wherein the one or more processors further cause the information processing apparatus to:
perform, in a case where the notification from the server indicates registration of the communication apparatus in the server fails, notification of the failure.

5. The medium according to claim 3, wherein in a case where the communication apparatus is discovered as a result of the search, information of the communication apparatus as an apparatus to be caused to execute the predetermined processing via the external access point is saved in the information processing apparatus.

6. The medium according to claim 3, wherein the predetermined processing includes print processing.

7. The medium according to claim 1, wherein the connection setting processing includes processing of connecting the information processing apparatus to the communication apparatus without intervention of the external access point.

8. The medium according to claim 1, wherein the connection setting processing includes processing of displaying a guidance screen for setting the communication apparatus in a predetermined mode.

9. The medium according to claim 8, wherein the predetermined mode is a mode in which the communication apparatus serves as a predetermined access point.

10. The medium according to claim 1, wherein the connection setting processing includes processing of transmitting, to the communication apparatus without intervention of the external access point, connection information for connecting the communication apparatus to the external access point.

11. The medium according to claim 10, wherein the connection information includes a Service Set Identifier (SSID).

12. The medium according to claim 1, wherein the registration information is acquired in connection between the information processing apparatus and the communication apparatus without intervention of the external access point.

13. The medium according to claim 12, wherein the registration information is acquired in the connection setting processing.

14. The medium according to claim 12, wherein after the connection setting processing, the information processing apparatus is connected to the external access point.

15. The medium according to claim 1, wherein the registration information includes a serial number of the communication apparatus.

16. The medium according to claim 1, wherein the server is a cloud server.

17. The medium according to claim 1, wherein the case where the communication apparatus is not discovered as a result of the search includes a case where the external access point is set so devices connected to the access point cannot communicate with each other.

18. An information processing apparatus comprising at least one memory and at least one processor which function as:
a connection setting unit configured to execute connection setting processing for connecting a communication apparatus to an access point outside the information processing apparatus and the communication apparatus; an acquisition unit configured to acquire registration information for registering the communication apparatus in an external server; a search unit configured to search for the communication apparatus via the external access point after executing the connection setting processing by the connection setting unit; and a transmission unit configured to transmit, in a case where the communication apparatus is not discovered as a result of the search by the search unit, the registration information acquired by the acquisition unit to the server.

19. A method executed by an information processing apparatus, comprising:
executing connection setting processing for connecting a communication apparatus to an access point outside the information processing apparatus and the communication apparatus; acquiring registration information for registering the communication apparatus in an external server;
searching for the communication apparatus via the external access point after executing the connection setting processing; and
transmitting, in a case where the communication apparatus is not discovered as a result of the search, the acquired registration information to the server.
